(19) United States
(12) Patent Application Publication
(10) Pub. No.: US 2019/0352238 A1
(43) Pub. Date: Nov. 21, 2019

(54) SYSTEMS AND METHODS FOR TREATING DAIRY WASTE

(71) Applicant: FIGURE 8, INC., SAN LUIS OBISPO, CA (US)

(72) Inventors: SCOTT HARRISON, SAN LUIS OBISPO, CA (US); SCOTT SEVERSON, SAN LUIS OBISPO, CA (US); ANDY ITURRIRIA, SAN LUIS OBISPO, CA (US)

(73) Assignee: FIGURE 8, INC., SAN LUIS OBISPO, CA (US)

(21) Appl. No.: 15/981,612

(22) Filed: May 16, 2018

(51) Int. Cl. C05F 3/00; C02F 9/00

(52) U.S. Cl. CPC C05F 3/00; C02F 11/04; C02F 9/00

(57) ABSTRACT

Systems and methods for collecting and processing livestock waste to facilitate the reclamation of water used in such processes and likewise produce fertilizer/soil amendments. Animal waste is initially collected, mixed with water and sequentially processed whereby large fibers present in the waste are separated, and the resultant manure sludge effluent. The manure sludge effluent may be treated with ultrasound, enzymatic pretreatment, aeration and/or polymers to promote coagulation and flocculation. A solids separation step is then performed to facilitate the separation of water and isolation of solids, the latter of which are formed into manure cakes and ultimately fertilizer/soil amendment products. The separated water is purified for reuse while further generating a nutrient concentrate.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention is directed to systems and methods for the collection and treatment of livestock waste whereby the waste is not only effectively and efficiently disposed of but is further converted into commercially useful products. The systems and methods of the present invention are further operative to facilitate water reclamation utilized in the waste collection and treatment process to thus conserve farming resources.

The management of livestock waste is among the most challenging tasks in commercial farming operations. In this regard, farm animals in the United States produce in excess of three hundred million tons of manure every year, with even a single beef cow producing over ninety pounds of manure every day. The risks associated with exposure to and contamination by livestock waste is universally understood to pose a risk to not only the livestock itself, but to water, land, the atmosphere and communities as well.

To date, there has not been a universally accepted best practice for livestock waste management and many farm operations must continuously alter and/or interrupt their farming practices to deal with the waste produced by the farm animals. Generally, such practices include one or a combination of either on-site waste management, composting, stockpiling the waste for use on farm property and/or stockpiling the waste for removal.

With respect to on-site manure management, such practice involves the collection, separation, storage and utilization of manure for farming purposes on farming property. Problematic with such practice, however, is the intensive effort needed to make sure that the animal waste does not contaminate water ways, such as creeks, wetlands and groundwater while further controlling greenhouse gas and odor generation. Such practice may also result in the degradation of soil health through the continual application of manure high in salts and nutrients.

Alternatively, such practices involve the collection, separation and storage of animal waste until such time that it can be transported offsite to composting facilities or to other industries that can utilize the resource. Problematic with such practices, however, is the intensive operations required to collect, manage, store and disseminate the waste in a proper manner that can further be interrupted by seasonal changes and affected by environmental changes and conditions.

Per a further known practice, animal waste is collected utilizing a fluid conveyance system that transports the animal waste from where it was deposited to pits where the water can be separated from animal waste. Problematic with such practices, aside from the intensive operations required, is the settling time required to separate solids and the greenhouse gasses and odors that are generated while the solids are separating by gravitational forces.

Composting is also a well-known practice that seeks to utilize collected animal waste that is subjected to drying and regular aeration, among other things, that ultimately conditions the animal waste into a useful soil amendment. Composting, unfortunately, requires significant time and effort and can likewise pose contamination risks thus rendering such practice too inefficient to be practical.

The practice of stockpiling simply involves the accumulation of animal waste over time for transport or containment on-site use at a future time. While such practice has the advantage of allowing a fixed area of land to be continuously utilized for other farming practices, storing the stockpiled waste for any length of time not only poses health risks, but requires further engineering considerations. Specifically, stockpiled animal waste is ideally kept dry and must be stored in an area that is not subjected to rainfall. Stockpiling further requires the use of reinforced containment walls so as to sufficiently contain the stockpiled waste. The animal waste must further be stored in a manner whereby the manure may be removed at a future time, which consequently leads to numerous issues regarding the ultimate transportation of the animal waste. With respect to the latter, not only are risks associated with the transfer and handling of stockpiled animal waste, there are numerous issues regarding the logistics of animal waste transportation from farms to other industrial operations that can make use of the waste, which often times involves transportation over great distances that in and of itself poses health and safety risks, increases greenhouse gas and the “carbon footprint” associated with such practices, and frequently becomes cost prohibitive. Indeed, Current farmers in the Midwest USA spend approximately $250,000-$400,000 on average per year to remove the manure from their property because they simply cannot use it on their own farm land.

Accordingly, there is a substantial need in the art for systems and methods that can be deployed on-site or in close proximity to livestock farming operations that can efficiently and effectively facilitate the collection and treatment of animal waste on an on-going basis whereby the livestock waste is not only satisfactorily removed from the farming premises, but is converted into commercially-useful products and can further facilitate the reclamation of water utilized in farming operations. There is likewise a need in the art for such systems and methods that can ultimately convert livestock waste into non-toxic, easily transportable materials, such as fertilizer and soil amendments that mitigate, if not eliminate, any health hazard associated with the originally-produced waste. Yet still further, there may be a need to concentrate manure in such a manner to improve gas generation in a digestor. Even further, there is a need to recycle water faster for reuse in farming operations. Still further, there is a need for such systems and methods that can be deployed on either a small scale or large-scale basis and thus operative to facilitate the collection and treatment of animal waste produced on virtually any scale of farming operations.

### BRIEF SUMMARY

The present invention specifically addresses and alleviates the above-identified deficiencies in the art. In this regard, the present invention is directed to systems and methods for the collection and processing of livestock waste whereby the waste is effectively and efficiently converted to non-toxic, commercially viable products, thus eliminating the risks of contamination and other nuisances associated with animal waste, and also facilitates the reclamation of water utilized in connection with the treatment process to thus conserve such resources and allow the same to be utilized in farming operations.

Generally, the process involves the initial step of livestock waste collection and separating the fibers therefrom and producing a manure sludge effluent. Typically, such waste collection practice will adhere to one of two recognized practices. In the first waste collection practice, which is indicative of dairies situated in the state of California, manure is collected and mixed with flush water to generate a manure admixture that is transported to an initial large fiber separator. Fiber separation is accomplished via the use of any of a variety of known separator mechanisms, such as rotary drums, slope screener other large fiber separators. In a preferred embodiment, a rotary conditioning and separation technique is utilized that is operative to separate the large fibers from the manure sludge admixture. Such large fibers, once isolated, are washed and used for other purposes, including use in bedding, compost or mulch.

In an alternative waste collection process indicative of dairies situated in the Midwest, the manure is collected and fed directly to an anaerobic digestor without the addition of any flush water. The anaerobic digestor, per conventional anaerobic bacterial degradation processes, naturally conditions and processes the manure after which the aforementioned fiber separation process is applied and the fibers are isolated from a manure sludge effluent. The fibers may then be utilized for a variety of purposes, including use in bedding, compost or mulch.

In any application, however, whether by mixing with flush water per California dairies or from post-anaerobic digestion per Midwest dairies or simply by directly removing the fibers from the manure, the resultant effluent manure sludge from which the large fibers are removed, is then subjected to a nutrient solids extraction step whereby the nutrient solids portion of the effluent are captured.

Prior to the nutrient solids extraction step, the resultant manure sludge effluent from which the large fibers are removed may optionally treated via a variety of processes. In a first optional step, the manure sludge effluent may be mixed with a polymer or blend of polymers, including but not limited to linear polyacrylamide, including cationic, nonionic, and anionic variations thereof, and for metal salts for coagulations such as aluminum sulfate, ferric chloride, ferric sulfate, aluminum chloralhydrate or aluminum chloride that facilitate the coagulation and flocculation of the solids present in the manure sludge. The coagulant/flocculent may also be selectively chosen to preserve the organic nature of the effluent. In further optional alternative steps, prior to or concurrent with the coagulation/flocculation step, the sludge may be subjected to ultrasound in either high intensity applications to facilitate the breakdown of materials present in the sludge or, alternatively, low intensity ultrasound applications to facilitate biological degradation of the sludge. It is likewise contemplated that the manure sludge may be subjected to digestive enzymes, such as lipases, proteases and the like, to facilitate the breakdown of biological materials present in the waste. The sludge may further be subjected to an aerification step whereby air, and more importantly the oxygen component thereof, is mixed with the manure sludge to facilitate microbiological degradation of the organic components present in the sludge.

In any application, once the nutrient solids present within the manure sludge are sufficiently removed, there will thus be derived a manure solids component that will contain at least 8% solids and a water component. The resultant water component will possess less than one percent solid. The reduction of solids in the separated water will advantageously reduce anaerobic decomposition rates, thus significantly reducing the generation of greenhouse gases while it is being stored for further use. The reduction of solids will also remove salts and other constituents that will preserve crop health if used for irrigation. To the extent desired, such water may be processed and purified further with steps including aerification, subjection to ultrasound, contact with appropriate microbes to facilitate clarification and also produce a nutrient concentrate. The water may further optionally be fed to a clarifier and then reverse osmosis where the water will be purified through conventional reverse osmosis processes. With respect to the latter, the water treated through reverse osmosis will thus be potable and suitable for use in livestock consumption, for irrigation, or water banking. The dissolved solid component isolated from the reverse osmosis process may be formed into a nutrient concentrate and sold as a commercial resource.

As discussed above, the solids component derived from the nutrient solids extraction step will essentially consist of a sludge containing approximately 8% nutrient solids. In some applications, the sludge may contain as much as 10% nutrient solids. Such 8% nutrient sludge may be fed to an anaerobic digestor to thus subsequently undergo anaerobic digestion to produce a byproduct that in turn may be fed to the manure sludge effluent produced as a byproduct of the initial large fiber separation process. Advantageously, utilizing the 8% nutrient sludge following anaerobic digestion provides for thickening of the manure sludge effluent and thus concentrates the nutrients for a more potent fertilizer when the sludge is re-subjected to the nutrient solid extraction step. Alternatively, the 8% nutrient sludge may be formed into a manure-type cake whereby the manure is squeezed via a press, such as a screw press, multi disc press or roller press. Advantageously, such cake contains approximately >99% phosphorous and 50% nitrogen found in the original flush water/waste combination mixed to form the initial admixture. The resultant cake, by virtue of having the water removed therefrom, possesses substantially less volume and fluidity than the original animal waste from which it was derived and, given the greater space efficiency due to reduced volume and stack-ability, may be more easily stored for use in on-site farm operations or transported off site for other applications.

Alternatively, the manure cake may be processed further and pelletized whereby the material is dried and compressed into space-efficient particles. In further refinements, the manure cake formation and pelletizing steps may incorporate applications of ultrasound to thus further reduce the mass associated with the processed animal waste material and/or may further be subjected to an aerobic digester to facilitate further microbiological degradation of the animal waste material. It is likewise contemplated that the resultant manure cake and/or pelletized material may be formulated and packaged as a commercial resource or, alternatively, may be mixed with other materials, and in particular activated carbon for use as a soil amendment that may be useful in soil remediation applications and the like. Other additives may further be mixed with the derived cake product, such as combining cellulose fiber, select bio polymer and or polymers and/or biological materials, such as fungi and the like, to produce and/or enhance an engineered soil product for a particular use. Indeed, it is expressly contemplated that the manure cake and pellet processing steps may be operative to derive an engineered soil product for use in commercial or residential applications.

### BRIEF DESCRIPTION OF THE DRAWINGS

These as well as other features of the present invention will become more apparent upon reference to the drawings.

FIG. 1 is a flow chart diagram depicting the initial steps for practicing the methods of the present invention whereby manure produced in dairy operations are segregated into fibers and a manure sludge effluent consistent with California dairy farm practices;

FIG. 1A is a flow chart diagram depicting alternative initial steps for practicing the methods of the present invention whereby manure produced in dairy operations are segregated into fibers and a manure sludge effluent consistent with Midwest dairy farm practices;

FIG. 2 is a flow chart diagram depicting the steps for practicing the methods of the present invention that are operative to derive an 8% nutrient sludge and less than 1% solids water from the manure sludge effluent produced by either process depicted in FIGS. 1 and 1A.

FIG. 3 is a flow chart diagram depicting the steps for processing the less than 1% solids water isolated via the steps performed in FIG. 2; and

FIG. 4 is a flow chart diagram depicting the steps for practicing a portion of the present invention whereby the 8% nutrient sludge may be processed according to two alternative routes.

### DETAILED DESCRIPTION

The detailed description set forth below is intended as a description of the presently preferred embodiment of the invention, and is not intended to represent the only form in which the present invention may be implemented or performed. The description sets forth the functions and sequences of steps for practicing the invention. It is to be understood, however, that the same or equivalent functions and sequences may be accomplished by different embodiments.

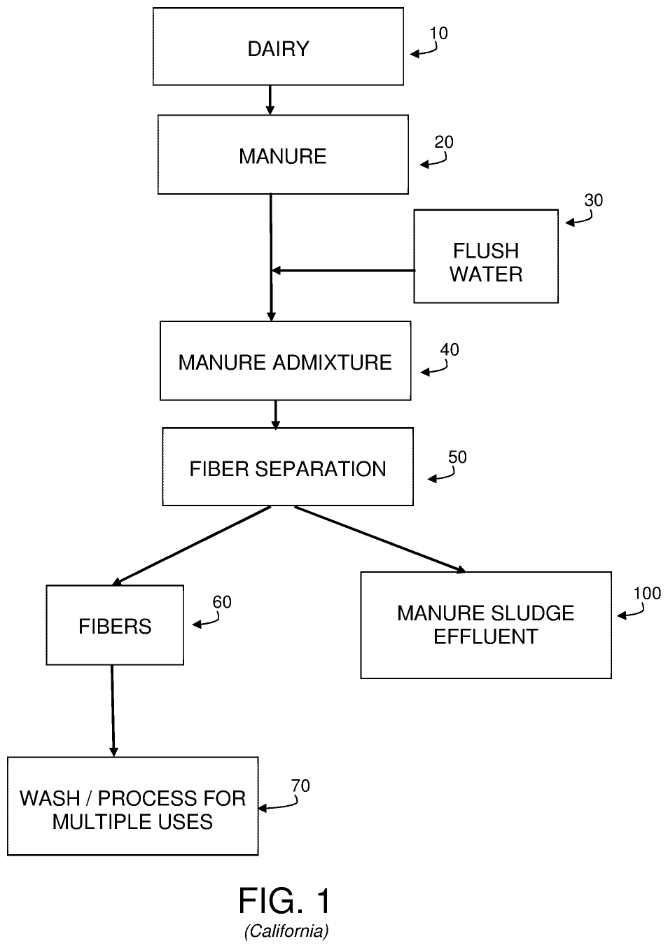

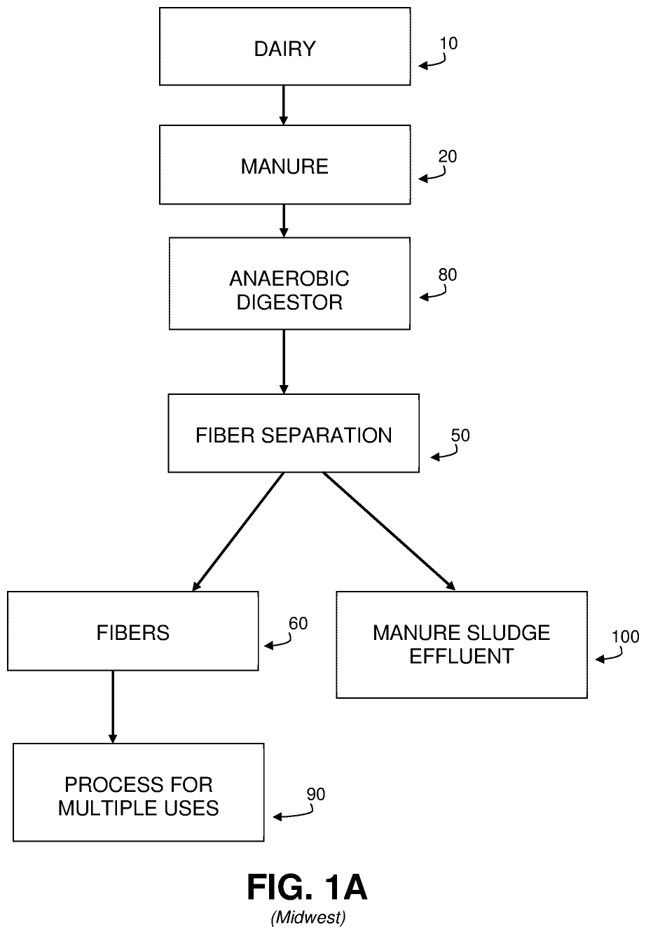

Referring now to the figures, and initially to FIGS. 1 and 1A, there is shown a comprehensive process for the recovery, treatment and repurposing of livestock waste as produced in the course of conventional livestock farming operations. In this regard, it is believed that the processes of the present invention may be utilized to treat any of a wide variety of livestock wastes produced by farming involving any of a variety of species of animals, whether it be hogs, poultry, cattle, and the like, as well as for use with animal waste produced in equestrian stable operations, zoos, animal shelters or any other application involving the care and maintenance of multiple animals. Accordingly, the term “animal waste,” as utilized herein, should be construed as broadly as possible; however, for purposes of the present invention, it is believed that the methods of the present invention are exceptionally effective in applications involving dairy farm operations that focus exclusively on dairy production. In this regard, and for purposes discussed more fully herein, the volume that is produced and the manner in which animal waste is collected brings on costly challenges of collection, handling, storage, separation, and disposal while simultaneously having the potential to environmentally impact to the atmosphere, surface and groundwater, soil health and creating a public nuisance of odor which the present invention directly addresses.

The process of the present invention will thus initially start with the farming operation, such as dairy farm 10 as shown. As shown in both FIGS. 1 and 1A, the dairy 10 will result in the production of manure 20 to which the present invention is directed. The processes of the present invention begin with the collection of the manure and ultimately to the treatment of that manure whereby the elongate fibers component 60 are isolated from the remaining manure sludge effluent 100. While the fibers may simply be removed directly from the manure, there are generally two discrete processes for achieving fiber removal that will essentially depend on how the manure is collected. FIG. 1 depicts dairy practices that are typical of California farming practices that utilize water as the main vehicle for moving and treating large quantities of manure. Per such practice, the manure 20 will initially be combined with flush water 30 to produce a manure admixture 40. Preferably, the flush water will be mixed with the animal waste in the amount ranging from 0.25-0.80 gallons per 2.2 pounds of manure. A typical dairy cow will produce about 1.9 cubic feet (i.e., 14 gallons or 120 lbs) of urine and feces per day requiring a typical range of 30 gallons/cow/day up to 150 gallons/cow/day to convey this water off the living and milking sections of a dairy.

The initial admixture 40 is thus formed that is fed to a fiber separator 50. Such fiber separator 50 can take any of a variety of configurations, and can include rotary drums, roller presses, slope screens or, in a preferred embodiment, a combination of rotary screen, washing/conditioning and screw press separator. Exemplary of combo separators include those produced by Trident Processes or Sumas, Wash., and Daritech of Lynden, Wash.

The purpose of the large fiber separator 50 is to remove as much of the large undigested fiber 60 as possible from the animal waste. In this respect, removing the undigested fiber is necessary to enable the fine solids present in the animal waste to be subsequently isolated, which in turn allows for complete de-watering of the animal waste or manure. The more efficiently the fibers 60 are separated from the initial admixture 40 of flush water and animal waste, the higher the amount of nutrient capture for fertilizer production and anaerobic gas generation, discussed more fully below. Moreover, once the fibers 60 are isolated, they may be washed and processed per step 70 for multiple uses, such as for bedding for the livestock or use in manufacturing soil amendments, among others.

With respect to the alternative steps for collecting manure and separating the same into fibers 60 and a manure sludge effluent 100, there is shown in FIG. 1A an alternative that does not rely upon flush water 30 per the California-type practices depicted in FIG. 1. In this regard, the steps shown in FIG. 1A are indicative of dairy farm operations situated in the Midwest whereby the manure 20 is directly fed to an anaerobic digestor 80 and thus bypassing any formation of a manure admixture. The anaerobic digestor 80 will be conventional in nature and operative to anaerobically degrade the manure per natural biological decomposition practices well-known to those in the art. Following the anaerobic digestion process 80, the manure derived therefrom will undergo the same fiber separation process 50 as discussed above which will result in the isolation of fibers 60 and a manure sludge effluent 100. With respect to the former, the same may be processed via a variety of techniques in the art and repurposed for other applications. As will be readily recognized, the isolated fibers 60 as derived in the process depicted in FIG. 1A will be post-anaerobic digestor materials verses the fibers produced in FIG. 1 that will not have undergone anaerobic digestion.

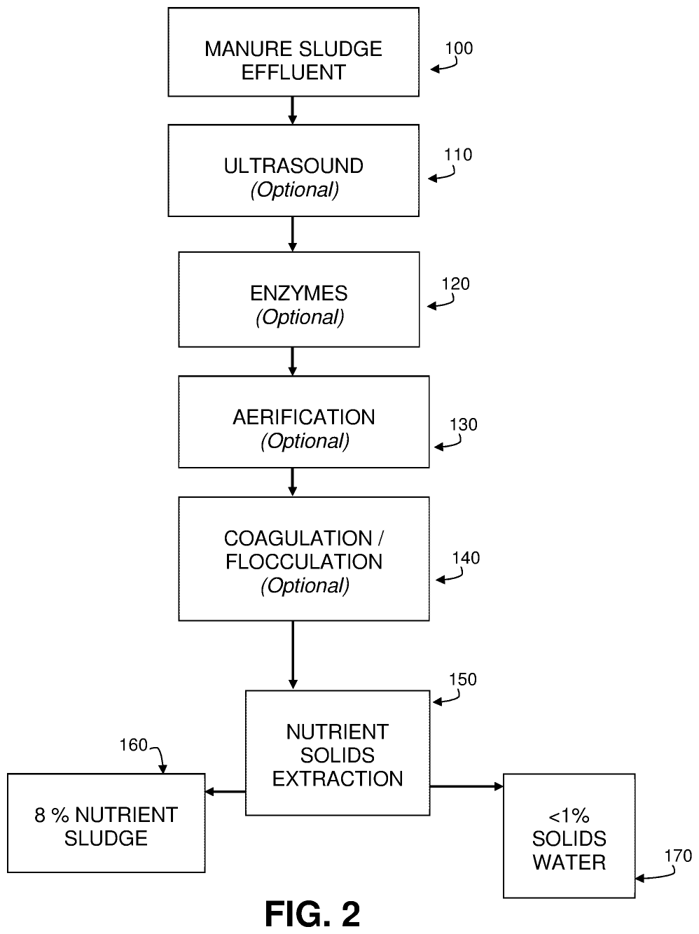

Regardless as to how the fibers 60 and manure sludge effluent 100 are derived, whether through direct removal or the specific processes shown in FIGS. 1 and 1A, the resultant manure sludge effluent 100 will typically have a total suspended solids (TSS) content of about 20,000 with the sludge containing approximately 1-3% solids. Importantly, such solids comprise most of the volatile solids that are desirable for fertilizer and soil amendment applications, and the better the sludge effluent 100, the higher quality fertilizer will ultimately be produced. To that end, there is depicted in FIG. 2 the steps to achieve that goal whereby the manure sludge effluent 100 is ultimately processed to create an 8% nutrient sludge 160 and a byproduct water having less than 1% solids 170.

Such components 160, 170 are derived through a nutrient solids extraction step 150, which essentially comprises a mechanical processing of the manure sludge effluent 100. Such mechanical interventions may take a variety of well-known forms in the art, such as dissolved air flotation, centrifugation, thickening tables, slope screens, lamella clarifiers, and the like. Also, expressly contemplated are the use of microfiltration devices that are operative to retain any solids and may further be treated by appropriate polymers. While custom units can be designed by those skilled in the art, commercially available systems may also be used. Exemplary of such systems include LWR, Trident Processes, DVO of Chilton, Wis., and Daritech.

Ideally, such extraction processes 150 will result in water having a 50% reduction in nitrogen and a 90% reduction of phosphorous compared to the initial flush water used in initiating the large fiber separation process. Such water separation step will further virtually eliminate all salts present in the water to thus facilitate the reuse of such water for a variety of applications. For example, potassium levels are reduced by as much as 70%.

Advantageously, the extraction step 150 via the use of mechanical intervention not only eliminates a substantial health risk present on farming operations, but also allows for better use of valuable land for additional livestock stalls and crop production. Such separation step also eliminates stagnant settlement ponds/lagoons, a well-known breeding ground for insects and other pathogens and a major producer of greenhouse gasses and odors on a farm. To that end, the water component 170 will have substantially reduced levels of phosphorous, nitrogen and salts, as well as almost all of the TSS. Such water is conditioned for use in farming applications, such as for irrigation or as flush water 30 as part of the initial large fiber separation process 50 as discussed above with respect to FIG. 1. In this regard, the less than 1% solids water 170 produced as a byproduct in FIG. 2 advantageously eliminates plugging in irrigations systems and allows for higher value crops that need precise irrigation. Likewise, cleaner flush water produced as a result of the solid separation step will reduce pathogens for overall health of the dairy cows and not only reduces the total water usage in farming operations, but because of the better quality reduces regulatory concerns concerning threshold purity needed for permissive use of the water in agricultural applications. Indeed, but for the processes of the present invention, the current best practices utilized today do not allow for manure water, or water produced as a result of the treatment of livestock waste to be utilized in most irrigation systems without plugging and would otherwise be absolutely incapable for utilization in low flow systems, such as drip irrigation. Compounding the problem further are recently enacted laws limiting water usage, such as Sustainable Groundwater Management Act (SGMA) starting in 2020 in California mandating the reduction of water use (even if one owns a well), which will force dairies to decide to either farm and change their dairy operation, or pull out the crops. These restrictive practices will thus not allow for both going forward. The present invention, however, removes such disadvantages of the prior art.

In further refinements of the invention, the manure sludge effluent 100 may be subjected to additional processing to better condition the sludge or, alternatively, promote a specific type of reaction to give the sludge a desired property prior to the extraction step 150. Specifically, it is contemplated that at least three different steps, namely the application of ultrasound 110, aerification 130 and/or coagulation and flocculation 140, may be utilized alone in combination to the extent desired. Such specific steps 110-140, however, are optional in nature and need not necessarily be utilized in order to practice the present invention.

With respect to optional step 110, ultrasound may be applied to the manure sludge in either a high or low intensity application. In this regard, it is contemplated that ultrasound applications that apply acoustic energy with frequencies ranging from 10 kHz to 20 mHz via ultrasonic probes, ultrasound baths, or a flat plate or tube-type ultrasonicators are operative to convert electrical energy into physical vibration and operative to influence the sludge medium to which the ultrasound is applied by imparting high energy thereto via cavitation, which in turn can affect the sludge in various ways such as by enhancing a biological reaction, reducing biomass volume, or degassing to facilitate the removal of ammonia, for example.

For purposes of the present invention, the ultrasonic application 110 may be a low intensity application, defined as >1W cm⁻² and between 1-10 mHz, which is considered non-destructive and does not kill or otherwise change the micro-organisms present in the manure sludge effluent 100. Such low intensity applications may be utilized to expedite microbial degradation of components in the manure sludge or otherwise facilitate a particular reaction. In this regard, it is contemplated that the manure sludge effluent 100 may be treated with any of a variety of enzymes per optional step 120, such as lipases, proteases and the like, that will be operative to digest targeted biomolecules present in the sludge to thus allow for more enriched fertilizer and soil amendment products, discussed more fully herein.

Alternatively, such ultrasonic application 110 may be a high intensity application, defined as 10-1,000W cm⁻² and 10-100 kHz, which consequently generates high pressure in the medium and can disrupt microbial structures. In this regard, such use of high intensity ultrasound is known in the art for use in reducing the biomass associated with animal waste, and in an exemplary application, can include ultrasonic irradiation from 35-130 kHz for time periods ranging from 5-20 minutes at an intensity of 50-60 watts per square centimeter. Exemplary equipment operative to impart the ultrasound to such mixture is commercially available from Hielsher USA, Inc. of Wanaque, N.J., and includes its UPI line of industrial ultrasonic devices.

In a further alternative, optional step that may be deployed to the manure sludge effluent 100, separate from any type of ultrasonic processing 110 or enzymatic treatment 120, is an aerification step 130 operative to introduce air, and in particular oxygen, to the manure sludge effluent 100 to thus facilitate microbiological degradation of the organic components present in the sludge. Such aerification step 130 may be accomplished through a conventional venturi or other means by which air and/or oxygen is introduced to the fluid stream. As a consequence, aerobic microbes present in the sludge begin to populate that allow for the further breakdown of the organic materials present in the sludge through natural digestive mechanisms. Key nutrients are subsequently placed in a better condition for separation and isolation, which in turn allows for the ultimate production of a more potent fertilizer product.

The manure sludge effluent 100, whether or not treated with optional enzymes 120, ultrasound 110 and/or aerification 130, may further be optionally subjected to coagulation and flocculation at step 140. As is known in the art, such process involves the use of chemicals and/or minerals and equipment that are operative to pull small solids together and making them large enough to separate from water. Such flocculation step 140 will typically utilize a combination of hardware and polymer chemicals, such as polyacrylamide and anionic, cationic and non-ionic varieties thereof. Either with complete automations or manually polymers and coagulants are made into dilution range of 0.01% to 5.0%, preferred dilution will be approximately 0.5-1.0%. Sometimes coagulants and polymers are added in separate steps and multiple times to achieve desired flocculation. The preferred embodiment dilution will be a combination of polymers and coagulants in a single dilution. The dilution will be introduced to the manure-stream from 25 ppm −2500 ppm of total volume. More precise will have treat rates of between 50 ppm-750 ppm, even more precise treat rate will be between 100 ppm-500 ppm. The dilution can be introduced to the manure stream at single or multiple locations. The preferred embodiment will utilize treatment columns with the stream flow coming from bottom to top, having multiple injections ports and chambers approximately 18 inches to 24 inches apart. As the stream is making its way up the columns, and more dilution is being introduced, creating very large flocs to form by the time the stream reaches the top of the columns. Exemplary flocculation columns include those made by LWR of Calgary, Alberta Canada.

To the extent desired, the coagulation/flocculation step 140 may utilize biopolymers and/or mineral-based flocculants, such as sodium bentonite so as to facilitate the purification of the manure sludge effluent 100 but at the same time preserving its organic status to thus expressly enable the processes of the present invention to be deemed organic in every respect. In this regard, while numerous steps of the present invention, including but not limited to 1-10-140, are optional in nature, it should be understood that any choice of steps utilized in the practice of the processes of the present invention may be expressly tailored such that the same are as eco-friendly as possible, conserve natural resources to the greatest extent available and further minimize the use of any chemicals or other man-made materials that could otherwise raise issues concerning public safety.

Regardless if optional steps 110-140 are performed, ultimately the manure sludge effluent 100 will be subjected to the nutrient solid extraction step 150 discussed above whereby the nutrient sludge component 160, on one hand, and a water component having a small amount of less than 1% fine dissolved solids 170 on the other hand, are separated from one another and processed via different routes.

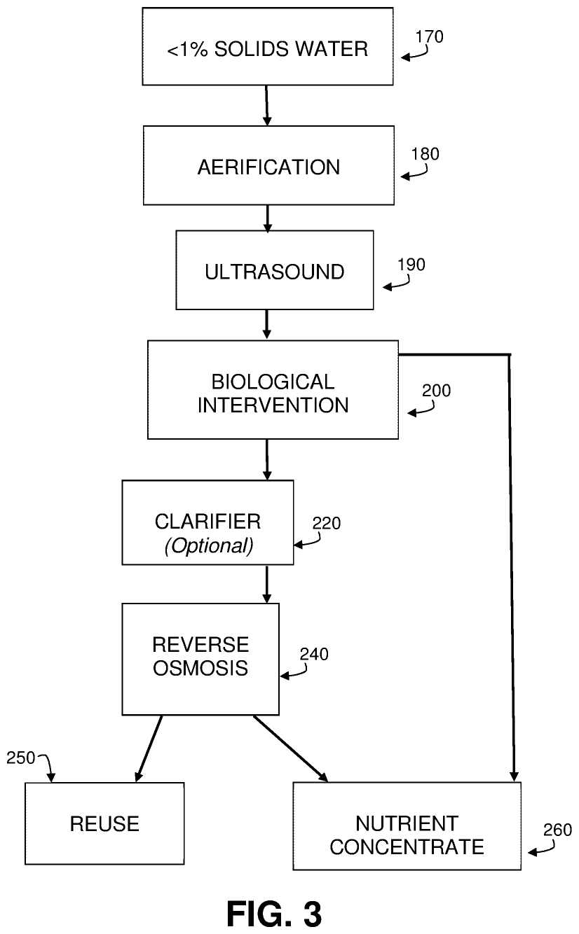

With respect to any further processing that may be utilized with the <1% solids water 170 generated in step 150, the same may be treated via the steps depicted in FIG. 3. As illustrated, the water may be subjected to aerification in step 180 whereby air and/or oxygen are introduced to the water to facilitate the growth of aerobic microbes to biodegrade any organic contaminants remaining in the water 170. In addition to or as an optional alternative, the water may be treated with an ultrasonic application 190, and in particular a high-intensity ultrasound application to eradicate any pathogens present in the water, as well as possibly a slight reduction in the biomass present in the water.

In a further optional step 200, the water 170 may be subjected to biological intervention, typically through a system of tanks and microbiological chambers whereby microbes biodegrade organics and other compositions present in the water to thus treat such dissolved contaminants, including ammonia. In an exemplary application, annamox bacteria may be deployed to facilitate the elimination of ammonia. As will be appreciated by those skilled in the art, the action of biodegradation further enhances the clarity and purity of the water for subsequent use in farming applications and may be achieved through known commercial techniques. Biological intervention 200 also will be operative to derive a nutrient concentrate 260 that in and of itself will be nutrient rich and operative to be utilized as a fertilizer product that will be created simply by virtue of clarifying the water 170 to enable the same to be reused.

In yet a further optional purification step, a clarifier 220 may be utilized following the biological intervention step 200. Any conventional clarifier 220, such as lamella and the like, that is operative to provide a further filtering effect on the water to the extent not accomplished in earlier filtering steps may be deployed. An exemplary clarifier is commercially sold by LWR.

Lastly, a reverse osmosis step 240 may be applied to ultimately eliminate all dissolved contaminants present in the water, which in turn eliminates all concerns associated with water restrictions associated with the animal waste treatment processes of the present invention. The resultant water 250 is a potable water source thus suitable for use in all farming applications, including irrigation and for use as drinking water with the dairy cows. The water produced in 250 may also be kept in reserve for water “banking” applications, credits or the like that will confer a benefit to the dairy operation as a result of its water conservation practices.

The isolated solids, in contrast, are concentrated 260 as a result of the reverse osmosis step 210 or, alternatively, produced directly from step 200 as shown. As discussed above, such concentrate 260 is, in and of itself, a nutrient rich byproduct capable for use in a variety of commercial fertilizer applications and will possess a nitrogen phosphorous potassium ratio of generally 0.2:0:0.3. In this regard, while typically considered waste, the nutrient concentrates 260 is contemplated as being useful in bulk shipments for organic farming operations and as pre-packaged products for use in hydroponic, nursery and cannabis growing applications. Accordingly, all solids ultimately derived from the processes of the present invention are useful in commercially-viable products and applications.

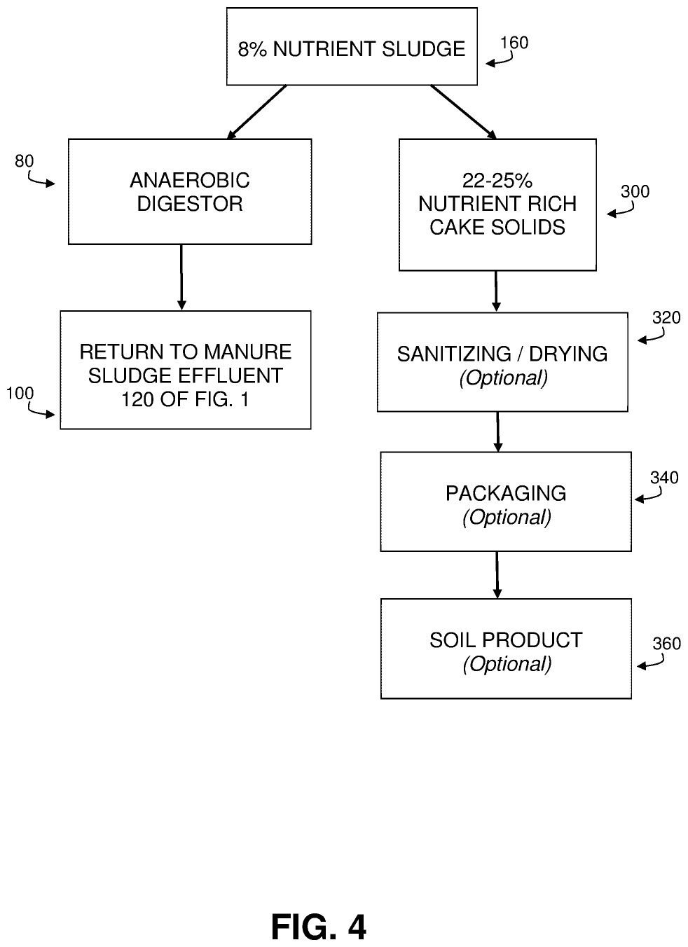

Referring now to FIG. 4, there is shown the route by which 8% nutrient solids 160 derived from nutrient solids extraction in step 150 of FIG. 2 are processed. The 8% nutrient sludge 160 includes high-value components containing phosphorous and nitrogen that are ideally suited for fertilizer applications. In certain refinements, the 8% nutrient sludge 160 can be as high as 10% solids. Advantageously, the 8% nutrient sludge 160 enables the nutrient components from the animal waste to be captured and eliminates the aforementioned practice of isolation ponds/lagoons that pose a number of health risks and numerous other disadvantages as discussed above.

With respect to such 8% nutrient sludge 160, the same may be processed by one of two routes. In a first option, the sludge is fed back to an anaerobic digester 80 whereby the sludge is acted upon by anaerobic bacteria in a reducing environment. Advantageously, anaerobic digestion 80, by virtue of receiving the 8% nutrient sludge 100 is far more concentrated than a feed stock having about 1% solids as such effluent would be derived per California practices (i.e., effluent 100 of FIG. 1). As a consequence, the anaerobic digestion 80 can occur in a much smaller vessel compared to prior art practices, which, in California, typically utilize massive covered lagoons. Indeed, by utilizing a sludge that is 8% to as high as 10% solids, the volume of the anaerobic digestor 80 may correspondingly be reduced to ½ to 1/10 the size of a conventional anaerobic digestor.

Still further, to the extent desired, the biproduct of anaerobic digestion 80, may be fed back to the manure sludge 100 as shown in FIG. 1 to thus thicken that initial manure sludge 100, to thus enrich the latter and subsequently concentrate the volatile solids and ingredients for an ideal fertilizer product, as discussed more fully below.

In an alternative route, the 8% nutrient sludge 160 may be subjected to further mechanical pressing to produce a nutrient rich cake solid 300 that is approximately 22-25% weight of the desired solids and will generally possess a nitrogen:phosphorous:potassium ratio of about 3:1:2. Such step may be accomplished by a number of mechanical actions, including presses, screw presses, multi-disk press, belt presses and the like and can be performed via commercial systems produced by Bauer of Voitsberg, Austria, Daritech and Trident. A screw press-type mechanism is typically preferred as it is operative to not only isolate the solids, but to concentrate them into a first cake material. Advantageously, such nutrient rich cake material is dry enough to stack for storage, transport, if desired, so as to enable the material to be hauled away for further processing at a remote location. Advantageously, by substantially removing the water component and concentrating the desired solids makes handling the materials much easier, safer and cost effective due to the substantially reduced volume and odor.

To the extent it is desired to further process the cake solids 300, the same may be further treated in steps 320 and 340 via sanitizing, drying and packaging steps as shown. In an exemplary method, the cake solids 300 will be heated sufficiently in step 320 to kill off any micro-organisms present. In a preferred method, the solids 300 will be heated to at least approximately 170 degrees Fahrenheit for at least approximately 30 minutes. In this regard, heating this material at such temperature for such duration is believed to meet all United States Department of Agriculture requirements for killing pathogens and weed seeds to thus ensure a product that is sanitary. Moreover, such drying step 320 further removes water, thus producing a dryer, lighter product that is easier to handle and transport. Such material will meet all organic fertilizer certifications believed to be applicable as of the submission of the present patent application.

To the extent desired, such dried material may be compressed further into a pelletized material, to thus concentrate the material for easier handling and transport. Along those lines, it is believed that such pelletized material can be packaged for commercial resale as organic fertilizer per step 340. In this regard, by packaging at step 340 and producing a commercial organic fertilizer enables the animal waste to ultimately be repurposed for not only commercial agricultural purposes, but for home and garden reclamation and revegetation markets.

In yet a further application, it is believed that the organic fertilizer ultimately produced may be combined with other materials, and in particular soil amendments, enriched soil and potentially soil remediation products so as to create an engineered top soil 360 that likewise may be separately marketed as a commercial product. To that end, it is believed that some of the large fibers originally isolated during the large fiber separation step 50 may be combined with the fertilizer as part of the engineered top soil product 360. It is likewise contemplated that the engineered top soil 360 can include components such as herbicides, insecticides, or even particulate activated carbon, the latter of which being well-known in the art for use in treating contaminated soil, and in particular, soil contaminated with toxic hydrocarbon materials. In this regard, it is believed that not only a viable fertilizer product can be produced, but ultimately an engineered top soil 360 that combines a number of benefits to the soil, including formulations that would be beneficial for soil and/or groundwater that is contaminated, particularly with hydrocarbon materials. In this regard, by bagging at step 340 and producing a commercial organic fertilizer combined with the large fibers and carbon materials enables the animal waste to ultimately be repurposed for not only commercial agricultural purposes, but for home and garden reclamation and revegetation markets.

Additional modifications and improvements of the present invention may also be apparent to those of ordinary skill in the art. Thus, the particular combination of parts and steps described and illustrated herein is intended to represent only certain embodiments of the present invention, and is not intended to serve as limitations of alternative devices and methods within the spirit and scope of the invention.

Moreover, the above description is given by way of example, and not limitation. Given the disclosure, one skilled in the art could devise variations that are within the scope and spirit of the invention disclosed herein, including various ways of processing livestock waste to separate, isolate and concentrate reusable solids from the waste while also conserving water usage. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for the treatment of livestock waste comprising the steps:
a) collecting manure generated by livestock;
b) administering a separation process to said manure collected in step a) to isolate substantially all of the large fibers present in said manure and further producing a manure sludge effluent;
c) performing a nutrient solids extraction to said manure sludge effluent produced in step b) so as to produce a nutrient sludge possessing at least 8% by weight solids and water containing less than 1% solids;
d) processing said water containing less than 1% solids in step c) to produce water and a nutrient concentrate byproduct;
e) concentrating said 8% nutrient sludge produced in step c) to produce a nutrient cake containing at least 22% solids; and
f) drying and sanitizing said nutrient rich cake solids produced in step e) to produce a fertilizer product.

2. The method of claim 1 wherein prior to performing said fiber separation process in step b), flush water is added to said manure to produce a manure admixture.

3. The method of claim 1 wherein prior to performing said fiber separation process in step b), said manure is first processed in an anaerobic digestor.

4. The method of claim 2 wherein said fibers isolated in step b) are washed and repurposed for other applications.

5. The method of claim 3 wherein said fibers isolated in step b) are washed and repurposed for other applications.

6. The method of claim 1 wherein prior to step c), said manure sludge effluent is treated with low-intensity ultrasound.

7. The method of claim 1 wherein prior to step c), said manure sludge effluent is treated with high-intensity ultrasound.

8. The method of claim 1 wherein prior to step c), said manure sludge effluent is subjected to at least one digestive enzyme.

9. The method of claim 1 wherein prior to step c), said manure sludge effluent is subjected to aerification.

10. The method of claim 1 wherein prior to step c), said manure sludge effluent is subjected to coagulation and flocculation.

11. The method of claim 1 wherein in step d), said water containing less than 1% solids is purified by at least one of aerification, application of ultrasound, biological intervention and reverse osmosis.

12. The method of claim 1 wherein in step e), at least a portion of said 8% nutrient sludge is treated by anaerobic digestion and thereafter returned to said manure sludge effluent generated in step b).
